(19) United States
(12) Patent Application Publication
(10) Pub. No.: US 2009/0024497 A1
(43) Pub. Date: Jan. 22, 2009

(54) Configuration Method and Engine for Inter-module Interfaces of Billing and Accounting

(75) Inventors: XIAOLE ZHANG, Nanjing (CN); BIN YANG, Nanjing (CN)

Correspondence Address: GLOBAL IP SERVICES, 7285 W. Eagle Court, Winton, CA, 95388, US

(73) Assignee: NANJING LIANCHUANG SCIENCE & TECHNOLOGY INC., LTD., Nanjing (CN)

(21) Appl. No.: 12/115,448

(22) Filed: May 5, 2008

(30) Foreign Application Priority Data
Jul. 20, 2007 (CN) 200710025308.1

(51) Int. Cl. G06Q 40/00

(52) U.S. Cl. 705/34

(57) ABSTRACT

The present invention relates to a configuration method for inter-module interfaces of billing and accounting system, the steps are as follows: 1) interface configuration method is stored in the billing and accounting system by a form of static library named as libcdr.a, it is an invoking relationship between a configuration engine of the inter-module interfaces and each functional module class, that is each functional module of the billing and accounting system invoking the configuration engine to complete an unified conversion transaction of input and output format; 2) automatic analysis of each service data is configurable; all configuration information is integrated in one unified configuration file cdr.ini, two types of data information transaction are supported in this configuration file: one is network element raw input data, other is standardized data in the system.

### CROSS REFERENCE TO THE RELATED PATENT APPLICATION

This patent application claims the priority of the Chinese patent application No. 200710025308.1 filed on Jul. 20, 2007, which is incorporated herein by reference.

### FIELD OF THE INVENTION

This invention is involved with the configuration engine for inter-module interfaces of billing and accounting system for mobile telecommunication system.

### BACKGROUND THE INVENTION

One of the development features of mobile telecommunication market is the rapid growth of the operations. As the leading domestic mobile telecoms carriers, China Mobile and China Unicom continuously generate new telecoms services during recent years, to increase the enterprise benefit and fit the growing requirements of the whole telecoms market. Currently there are abundant mobile telecoms services, which can be categorized as voice service, short message service, data service, value added service, etc. These different mobile services are involved with different switch network element equipments. Different network element equipments generates the raw data with different format requirements, which is provided to billing and accounting system of business supporting system for charging transaction. According to statistics, presently there are around fifty to sixty formats of raw data for one provincial billing and accounting system. For some provinces with developed mobile services, there are even more than one hundred formats. Along with the coming of 3G generation, the billing and accounting system will deal with increasingly more types of network element data. Furthermore, the major point of billing and accounting system is the background operation system for mass data transaction. The system consists of several processes, including pre-transaction, sorting, charging, roaming interface, accounting transaction, credit control, information input, etc. So there is higher requirement of the design and technology of the billing and accounting system according to the multiple formats of raw data and complex transaction process in the system. The rational inter-module interface design of billing and accounting system has become the key point for quick respond of new customer service and rational flow of different data among system modules.

In order to solve above problem and avoid adding huge amount of development and upgrading workload of the supporting system when new service data source occurs, it has become the industrial development trend to adopt configurable products for billing and accounting system. The key examples of configurable products include the unified version product from domestic leading supporting system providers and packaged software from foreign billing system producers (like AMDOCS). The configuration of interfaces among multiple modules within the billing and accounting system is a key indicator of the production of the whole billing and accounting systems. Billing system providers home and abroad have different technical implementation in this aspect. The technology “Configuration Method and Engine of System Inter-model Interfaces” is a unique technology in this domain developed by applicants. This technology has competitive advantages in improving the flexibility, security, extensibility and high efficiency of the billing and accounting system. Along with the rapid development of mobile telecoms services, multi-format service data sources need supporting system transaction, which raises high request to the production and configuration degree of billing and accounting system.

### SUMMARY OF THE INVENTION

The objectives of this invention is: in order to enhance the supporting capability of billing and accounting system to respond new services, avoid adding huge amount of development and upgrading workload of the supporting system when new service data source occurs, and improve the flexibility and extensibility of billing and accounting system, applicants designed “Configuration Method and Engine of System Inter-model Interfaces” to implement full configuration of inter-module interface of billing and accounting system and erase the risk and influence from network element raw data information to the functional upgrading of billing and accounting system.

### Technical Solutions:

Interface configuration method is stored in the billing and accounting system by the form of static library (the static library is named as libcdr.a); it is the invoking relationship between the configuration engine of inter-module interfaces and each functional module class, that is each functional module of billing and accounting system invoking configuration engine to complete the unified conversion transaction of input and output format; the core data structure of interface configuration engine is as below:
Definition structure of the field position length of input data information
Definition structure of configuration analysis of service data
Definition structure of internal bill fields

The automatic analysis of each service data is configurable. All the configuration information is integrated in one unified configuration file cdr.ini. Two types of data information transaction are supported in this configuration file: one is the network element raw input data; the other is the standardized data in the system

The structure of configuration file consists of two levels:
First level data structure configuration
   # Network element raw input data
      # standardized data in the system
level two data structure configuration

The steps are:
1) read configuration information according to configuration file name and
initialize bill class objects
Input: full path and file name of the configuration file
Open configuration file:
   Read the configuration information within
   <INTERNAL> ordinally
   After get information parse, ordinally put into m_interparams
   Initialize the CRecord object, and put object into m-outRecs
   Read configuration information in <TYPES> ordinally
   After get information parse, ordinally put into m_interparams
Initialize the CRecord object, and put object into m-outRecs2) insert the field of internal bill configured in <TYPES> into CRecord, for later use: Parse the position of each configuration field of <TYPES> in CRecord, for the use of output bill Throw exception CException, and end transaction
3) get the configuration information, which is required to deal with some bill by some class, according to the file name. This process is invoked by the sorting module before analyzing the bill, once for every file Input: bill file name currently transacted Faintly match the member using this object (tp_patterns) ordinally with fileName
4) Parse the bill in the file got from the integrated collection, for the sorting module to invoke
Input: String index of the bill to be transacted
If (the type of this bill is fixed length)
Parse the fixed length bill according to the configuration information in m_tpIt. Put the bill after parse into the object pointed by m_prec.
If there is fault during transaction process, then throw CException
Parse the bill according to the compartition configured in m_tpIt. Put the bill after parse into the object pointed by m_prec.
If there is fault during transaction process, then throw CException
5) Set up internal bill type currently transacted
Input: bill file name currently transacted
Find the file corresponding bill type from the relationship between file name and internal bill type
Find the corresponding VecInterField object from m_interparams by using the corresponding bill type, and put value to m_ofIt
If there is fault during transaction process, then throw CException
6) Parse the internal bill format
Input: String index of the bill to be transacted Read field name from m_ofIt ordinally, and get the field from buf
Put the value of filed into m_prec according to field name
7) Get internal output bill format
Input: string index storing output
Output: formatted output string
Read the field name from m_ofIt ordinally, and get the position of each field in m_prec
Get field from m_prec, connect and output string
8) Get internal output bill format
Input: string index storing output, bill format of compelled output
Output: formatted output string
Find corresponding VecInterField object in
m_interparams according to type
Read field name ordinally from VecInterFiled obtained, and get the position of each field in m_prec
Get the field from m_prec, connect and output string
Declare CCDR index
Generate CCDR object; INTER CDMA is the module name in the configuration file
Directly get the corresponding values of the field according the field name of configuration file
Directly configure the corresponding values of the field according the field name of configuration file

“Configuration method and engine of system inter-module interfaces” is one of the core basic components of billing and accounting system, which is developed by C++ language, and stored in the billing and accounting system by the form of static library (the static library if named as libcdr.a). It is the invoking relationship between the configuration engine of inter-module interfaces and each functional module class, which is each functional module of billing and accounting system invoking configuration engine to complete the unified conversion transaction of input and output format.

The core data structure of interface configuration method and engine is described by C++ language, the C++ grammar keywords involved in data structure is explained in table below:

| English | |
|---|---|
| Word | Keywords Meaning Explanation |
| typedef | Definition of data type |
| struct | Definition of structural data type |
| string | Definition of string data type |
| int | Definition of integer data type |
| bool | Definition of boolean data type |
| vector | Vector data type, one of the container |
| | data types in C++ |
| iterator | Iterator description |

The detailed explanation of core data structure is described below:

```
Definition structure of the field position length of
input data information
Definition structure of configuration analysis of
service data
Definition structure of internal bill fields
typedef struct _FixField //”FixField Define input
data structure FixField”
{
        string ff_name; //“Field Name”
        int ff_begin; //”Field Starting Position”
        int ff_length; //” Field Length”
} FixField;
Definition structure of configuration analysis of
service data
typedef struct _TypeParam //TypeParam Define data
configuration information structure TypeParam
{
    string tp_name; //” Type name”
    vector<string> tp_patterns; //” file type”
    bool tp_fix; //”whether fixed length data”
    string tp_inter; //” internal data format need to
  be transferred”
    vector<FixField> tp_fields ;//” description
    information of field”
} TypeParam;
typedef vector<TypeParam> VecTypeParam; //”define
vector type”
typedef vector<TypeParam>::iterator VecTypeParamIt;
//” define vector alternator “
Definition structure of internal bill fields
typedef struct _InterField //”InterField Define
internal bill structure InterField”
{
    string of_name; //” Field Name”
    int of_pos; //” Field Position”
} InterField;
typedef vector<InterField> VecInterField; //” Define
Vector Type”
typedef vector<InterField>::iterator VecInterFieldIt;
//” Define Vector alternator”
```

The feature of module interface configuration method and engine is that the automatic analysis of each service data is configurable. All the configuration information is integrated in one unified configuration file cdr.ini. Two types of data information transaction are supported in this configuration file: one is the network element raw input data; the other is the standardized data in the system.

The structure design explanation of configuration file is as below:

```
    the first level data format configuration
          # data configuration of network element original
input
          <OUTSIDE> # starting mark of network element
external data configuration
            </OUTSIDE> # ending mark of network element
external data configuration
          # system internal standardized data
          <INTERNAL> #starting mark of the system internal
data configuration
            </INTERNAL> # ending mark of the system
internal data configuration
    the second level data format configuration
          TYPENAME = inter_gsm # define the GSM voice
data format name
          OUTTYPE = inter_gsm # output GSM voice data
format
          <HEAD> # starting mark of head record format
definition of data file
            SEPERATOR = # separator of head record of data
file
          <FIELDS> # starting mark of head record field
of data file
                head , 1, 177, # starting position and
leagth of head record field
            </FIELDS> # ending mark of head record
field of data file
          </HEAD> #ending mark of head record format
definition of data file
          <BODY> # starting mark of body format definition
of data file
            SEPERATOR = # separator of record body
            <FIELDS> # starting mark of body record
field of data file
                  call_type ,1, 2, # call type
                  msisdn ,1, 11, # mobile
number
                  ...
            </FIELDS> #ending mark of body record
field of data file
          </BODY> #ending mark of body format
definition of data file
```

### Application Scope:

“Configuration Method and Engine of System Inter-model Interfaces” can deal with all the present mobile telecoms data. It can be widely applied in billing and accounting system, with detailed explanation as below:
Support the configuration analysis of various mobile telecoms service data deployed presently, including voice service (GSM Network, CDMA Network), short message service (GSM Network, CDMA Network), Data Service (GPRS, CDMALX), and value-added service (flux, content). It can also support various service data deployed in the future 3G generation.

### System Requirement:

Flexibility: Configuration Method and Engine can satisfy differentiated configuration for all mobile telecoms service data formats. The codes of system do not need any upgrading modification;
Security: Configuration Method and Engine has strong mechanism of security and fault tolerance to ensure the high-level usability and continuity of the transfer of system functional modules, so as to increase the service operation level and ensure the operation supporting quality;
Extensibility: Configuration Method and Engine has fully considered the demand of future function extension during its design phase. The technical implementation has ample prospective ability;
High Efficiency: Configuration Method and Engine can complete real-time transaction of large quantity of data, which fully satisfy the mass data transaction requirements of billing and accounting system;
Accuracy: Configuration Method and Engine provides multiple checking and auditing methods and fully considers the backward fault-tolerant mechanism for data exceptions to ensure the accuracy of the data transaction.

### Beneficial Effects:

Increase the responding speed of billing and accounting system for new service support, avoid adding huge amount of development and upgrading workload of the supporting system when new service data source occurs, improve the flexibility and extensibility of billing and accounting system
Configuration method and engine of system inter-module interfaces implement full configuration of inter-module interface of billing and accounting system and erase the risk and influence from network element raw data information to the functional upgrading of billing and accounting system.
Make the functional module interfaces as the borders of billing and accounting system, parse the business process and data information of each functional module to get functional division, divide the system functions by layers, and enhance the system ability of fault-tolerance
Enhance the production level of billing and accounting system, lower down the cost of software maintenance and upgrading for telecoms carriers, and maximize the value of the mature billing and accounting product

### BRIEF DESCRIPTION OF DRAWING

FIG. 1 is The relationship graph between interface configuration method and engine and each functional module entities of billing and accounting system.

FIG. 2 is shown as The major class design graph of interface configuration method and engine.

### DETAILED DESCRIPTION OF THE INVENTION

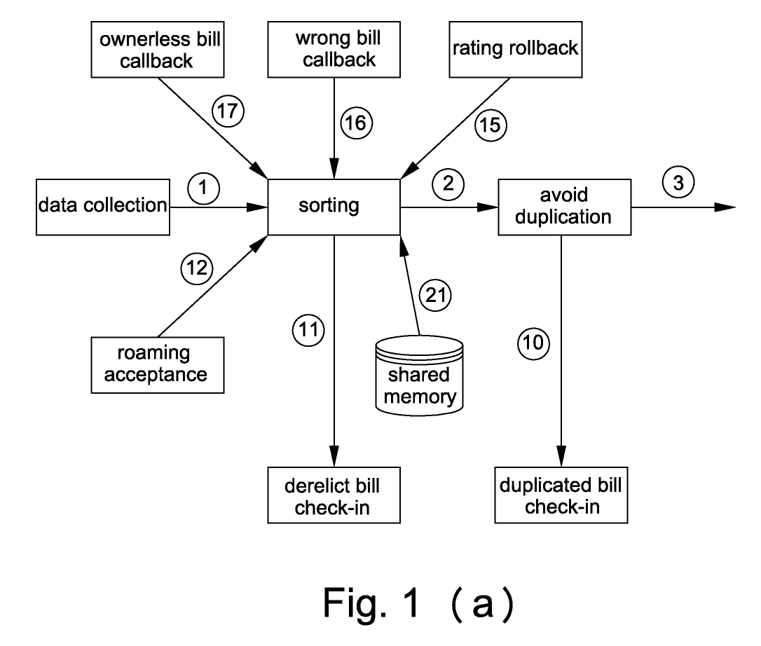

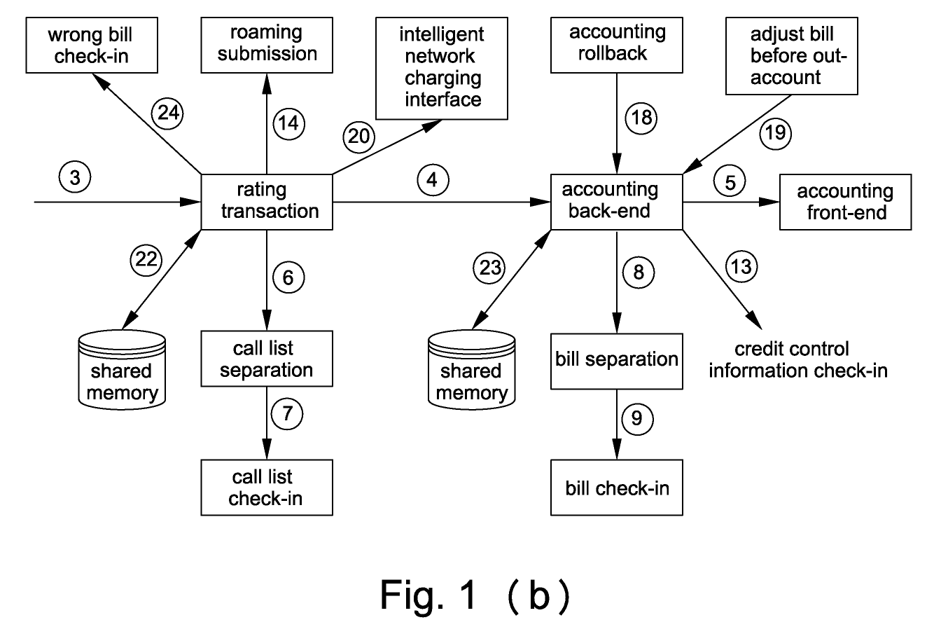

The number tabs in FIG. 1 show the flowing sequence of data information among each functional module in billing and accounting system. They are also the marks of invoking configuration method and engine by each module. Thus it can be seen that the complexes interface relationships in the system are unified by configuration method and engine. Each functional module only needs to care about the details of service implementation, without thinking about the boundary interface information among modules.

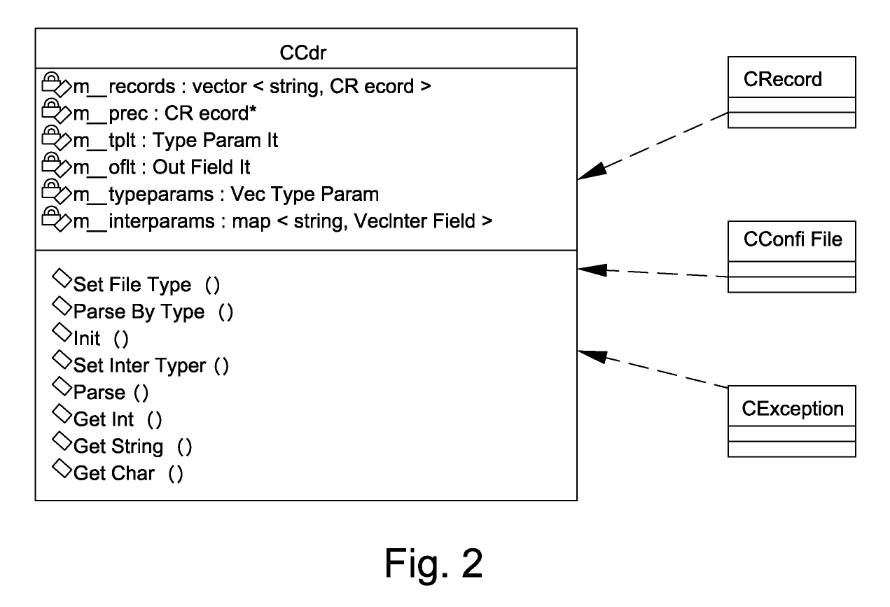

The major class design graph of interface configuration method and engine is shown as FIG. 2.

The transaction processes of major class functions are explain separately by pseudocode method. The meanings of English words involved in pseudocode are explained in the table below. (The English words which have been explain in chapter 3 will not be explain again here)

| English Word | Meaning Explanation |
|---|---|
| void | null data type in c++ |
| const | constant type in c++ |
| CRecord | Basic class of data file record |
| CConfiFile | Basic class of data configuration |
| | method |
| CException | Class of exception transaction |
| CCdr | Class of configuration method of |
| | module interfaces |
| &fileName | Variable of data record configuration |
| | file |
| m_interparams | Mapping variable of internal data |
| | parameter structure |
| m_outRecs | Variable of output data record |
| m_typeparams | Variable of data configuration of |
| | parse information |
| m_inRecs | Variable of input data record |
| throw | Exception log information thrown by |
| CException | system exception |
| INTERNAL | First level data format configuration |
| TYPES | Second level data format |
| | configuration |
| tp_patterns | Variable of data configuration parse |
| | member |
| m_tpIt | Middle variable of data configuration |
| | parse index |
| tp_inter | variable of m_tpIt index member |
| m_prec | Index variable of data file record |
| | basic class |
| m_ofIt | Middle variable of output data record |
| buf | Index variable of string cache |
| m_pDataCdr | Index object variable of module |
| | interface configuration method |
| new | Keywords of object grammar in C++ |
| m_SBody | Variable member of getting value of |
| | object m_pDataCdr |
| GetString | Get value function of appointed record |
| | field |
| m_SBody | Variable member of setting value of |
| | object m_pDataCdr |
| SetString | Setting value function of appointed |
| | record field |

```
    Flow explanation of initialization function Init of
    inter-module interface configuration
    /* description: read configuration information
according to configuration file name and initialize bill
class objects
      Input: full file path and file name of configuration
file
      Output: n/a
      Return: void
      Implementation: */
    void CCdr::Init(const string &fileName)
      Open configuration file
      Read configuration information in <INTERNAL>
ordinally
          Get information parse and put into m_interparams
ordinally
          Initialize CRecord object and put object into
m_outRecs
      Read configuration information in <TYPES> ordinally
          Get information parse and put into m_interparams
ordinally
          Initialize CRecord object and put object into
m_outRecs
      insert the field of internal bill configured in
    <TYPES> into CRecord, for later use:
      Parse the position of each configuration field of
    <TYPES> in CRecord, for the use of output bill
      Throw exception CException, and end transaction
    flow explanation of setting file type configuration
    function SetFileType
      /* description: Get the configuration information,
which is required to deal with some bill by some class,
according to the file name. This process is invoked by the
sorting module before analyzing the bill, once for every
file
      Input: bill file name currently transacted
      Output: n/a
      Return: bool
      Implementation: */
    void CCdr::SetFileType(const string &fileName)
      while( the objects in m_typeparams have not been
traversed) {
          Get one object from m_typeparams
          Faintly match the member using this object
(tp_patterns) ordinally with filename
          if(find corresponding configuration
information) {
            Set the index of this object as the value to
m_tpIt
              Meanwhile find corresponding index of
CRecord object from m_tpIt->tp_inter, and set value to
m_prec
              return;
          if can not find corresponding configuration
information throw CException
    flow explanation of data configuration type parse
    function ParseByType
    /* description: Parse the bill in the file got from the
integrated collection, for the sorting module to invoke
      Input: String index of the bill to be transacted
      Output: n/a
      Return: bool
      Implementation: */
    void CCdr::ParseByType(char* buf)
    If (the type of this bill is fixed length)
    Parse the fixed length bill according to the
configuration information in m_tpIt. Put the bill after
parse into the object pointed by m_prec.
      If there is fault during transaction process, then
    throw CException
          Parse the bill according to the compartition
configured in m_tpIt. Put the bill after parse into the
object pointed by m_prec.
          If there is fault during transaction process, then
    throw CException
    flow explanation of internal bill type get value
    function SetInterType
    /* description: set up internal bill type currently
transacted
      Input: bill file name currently transacted
      Output: n/a
      Return: void
      Implementation: */
    void CCdr::SetInterType(const string &fileName)
    Find the file corresponding bill type from the
relationship between file name and internal bill type
    Find the corresponding VecInterField object from
m_interparams by using the corresponding bill type, and
put value to m_ofIt
    If there is fault during transaction process, then throw
CException
      flow explanation of internal bill type format
    parse function Parse
    /* description: parse the internal bill format
      Input: String index of the bill to be transacted
      Output: n/a
      Return: void
      Implementation: */
    void CCdr::Parse(char *buf)
      Read field name from m_ofIt ordinally, and get the
    field from buf
          Put the value of filed into m_prec according to
field name
    flow explanation of output internal format bill by
    default method function GetOutput
    /* description: get internal output bill format
      Input: string index storing output
      Output: formatted output string
      Return: void
          Implementation: */
      void CCdr::GetOutput(char *buf)
          Read the field name from m_ofIt ordinally, and get
      the position of each field in m_prec
          Get field from m_prec, connect and output string
      flow explanation of output internal format bill by
      compelled method function GetOutput
      /* description: get internal output bill format
          Input: string index storing output, bill format of
      compelled output
          Output: formatted output string
          Return: void
          Implementation: */
      Find corresponding VecInterField object in
    m_interparams according to type
      Read field name ordinally from VecInterFiled obtained,
    and get the position of each field in m_prec
          Get the field from m_prec, connect and output string
      Declare CCDR index
      Generate CCDR object; INTER CDMA is the module name in
the configuration file
      Directly get the corresponding values of the field
according the field name of configuration file
            Directly configure the corresponding values of
    the field according the field name of configuration file
      void CCdr::GetOutput(char *buf, const string *type)
      Find corresponding VecInterField object in
    m_interparams according to type
      Read field name ordinally from VecInterFiled obtained,
    and get the position of each field in m_prec
      Get the field from m_prec, connect and output string
      Application sample of configuration method and engine:
      By using configuration method and engine, it can be
    easily completed to get value and setup for one field in
    the file
      Take charging program in billing system as example:
      // Declare CCDR index
      CCDR *m_pDataCdr;
      // Generate CCDR object; INTER CDMA is the module name
    in the configuration file
      m_pDataCdr = new CCDR(“INTER_CDMA”);
      // directly get the corresponding values of the field
    according the field name of configuration file
      //for example: get the calling mobile number m_msisdnA,
    called number m_msisdnB, calling duration datatime etc.
```

| | |
|---|---|
| m_msisdnA | = |
| m_pDataCdr->m_SBody->GetString(“RSRCID”); | |
| m_msisdnB | = |
| m_pDataCdr->m_SBody->GetString(“ORSRCID”); | |
| string datatime | = |

```
    m_pDataCdr->m_SBody->GetString(“START_DATE”);
      // directly configure the corresponding values of the
    field according the field name of configuration file
    //for example: set up roaming type ROAM_TYPE, long
distance type LD_TYPE etc.
    m_pDataCdr->m_DBody->SetString(“ROAM_TYPE”,“1”);
    m_pDataCdr->m_DBody->SetString(“LD_TYPE”,“3”);
```

The “configuration method and engine of system inter-module interfaces” from Linkage has already been packaged in the supporting products for carriers. Along with the construction and implementation, it has already been implemented in the China Unicom's integrated billing and accounting system in provinces and areas like GuiZhou, AoMen, etc. It is easy to implement and running stably, which is highly satisfying to clients and add great value to the society.

What is claimed is:

1. Configuration method for inter-module interfaces of billing and accounting system, comprising:
1) interface configuration method is stored in the billing and accounting system by a form of static library named as libcdr.a, it is an invoking relationship between a configuration engine of the inter-module interfaces and each functional module class, that is each functional module of the billing and accounting system invoking the configuration engine to complete an unified conversion transaction of input and output format; a core data structure of interface configuration engine is as below:
Definition structure of field position length of input data information,
Definition structure of configuration analysis of service data,
Definition structure of internal bill fields;
2) automatic analysis of each service data is configurable; all configuration information is integrated in one unified configuration file cdr.ini, two types of data information transaction are supported in this configuration file: one is network element raw input data, other is standardized data in the system.

2. The configuration method for inter-module interfaces of billing and accounting system of claim 1, a structure of the configuration file comprises two levels:
First level data structure configuration:
# Network element raw input data,
190 standardized data in the system;
level two data structure configuration has steps are as follows:
1) read configuration information according to configuration file name and initialize bill class objects,
Input: full path and file name of the configuration file,
Open configuration file:
read the configuration information within <INTERNAL> ordinally,
after get information parse, which is ordinally put into m_interparams,
initialize a CRecord object, which is put into m-outRecs,
read the configuration information in <TYPES> ordinally,
after get information parse, which is put into m_interparams,
Initialize the CRecord object, which is put into m-outRecs;
2) insert a field of internal bill configured in <TYPES> into CRecord, for later use:
parse a position of each configuration field of <TYPES> in CRecord, for use of output bill,
throw exception CException, and end transaction;
3) get the configuration information, which is required to deal with some bills by some classes according to the file name, this process is invoked by a sorting module before analyzing the bills, once for every file,
input: bill file name currently transacted,
iaintly match a member using this object (tp_patterns) ordinally with filename;
4) parse a bill in a file got from the integrated collection, for sorting module to invoke,
input: String index of the bill to be transacted if (the type of this bill is fixed length),
parse the fixed length bill according to the configuration information in m_tpIt. Put the bill after parse into an object pointed by m_prec,
if there is fault during transaction process, then throw CException,
parse the bill according to compartition configured in m_tpIt, Put the bill after parse into the object pointed by m_prec,
if there is fault during transaction process, then throw CException;
5) set up internal bill type currently transacted,
input: bill file name currently transacted,
find the file corresponding bill type from a relationship between file name and internal bill type,
find a corresponding VecInterField object from m_interparams by using the corresponding bill type, and put value to m_ofIt,
if there is fault during transaction process, then throw CException;
6) parse the internal bill format,
input: string index of a bill to be transacted
read field name from m_ofIt ordinally, and get a field from buf,
put the value of the filed into m_prec according to field name;
7) get internal output bill format,
input: string index storing output,
output: formatted output string,
read a field name from m_ofIt ordinally, and get a position of each field in m_prec,
get the field from m_prec, connect and output string;
8) get internal output bill format,
input: string index storing output, bill format of compelled output,
output: formatted output string,
find corresponding VecInterField object in m_interparams according to type,
read the field name ordinally from VecInterFiled obtained, and get a position of each field in m_prec,
get a field from m_prec, connect and output string, declare CCDR index,
generate CCDR object; INTER CDMA is a module name in a configuration file,
directly get corresponding values of the field according the field name of the configuration file,
directly configure corresponding values of the field according the field name of the configuration file.
